(19) United States
(12) Patent Application Publication
(10) Pub. No.: US 2019/0378292 A1
(43) Pub. Date: Dec. 12, 2019

(54) METHOD AND SYSTEM TO SPATIALLY REGISTER AN IMAGING SYSTEM TO A SAMPLE CONTAINER

(71) Applicant: Perimeter Medical Imaging Inc., Toronto (CA)

(72) Inventors: David REMPEL, Toronto (CA); Chao FAN, Toronto (CA); Carl GAZDZINSKI, Mississauga (CA); Navid SAMAVATI, Toronto (CA)

(73) Assignee: Perimeter Medical Imaging Inc., Toronto (CA)

(21) Appl. No.: 16/430,675

(22) Filed: Jun. 4, 2019

Related U.S. Application Data
(60) Provisional application No. 62/681,745, filed on Jun. 7, 2018.

(51) Int. Cl. G06T 7/70; G01N 21/55; B01L 3/00; G06T 7/00

(52) U.S. Cl. CPC G06T 7/70; G01N 21/55; G06T 1/0007; G06T 7/0012; B01L 3/50

(57) ABSTRACT

A method and system for registering an imaging system to a sample container include a sample container configured to support a biological tissue sample and an imaging system for generating optical images of the biological tissue sample. The sample container includes an imaging window having a top surface in contact with the biological tissue sample and a bottom surface. The imaging system includes a scanning area that receives a portion of the sample container and an imaging device disposed below the scanning area. The imaging device emits a focused sample light signal towards the imaging window and receives a reflected sample light signal from the imaging window. By scanning the focal point of the sample light signal and measuring the reflected sample light signal, the location of the top surface of the imaging window can be determined, thus registering the imaging device to the imaging window of the sample container.

### CROSS-REFERENCE TO RELATED APPLICATIONS

This application claims priority to U.S. Provisional Patent Application No. 62/681,745, filed Jun. 7, 2018, titled “METHOD AND SYSTEM TO SPATIALLY REGISTER AN IMAGING SYSTEM TO A SAMPLE CONTAINER,” the disclosure of which is incorporated by reference herein.

### BACKGROUND

Embodiments described herein relate to a method and system for registering an imaging system to a sample container. In medical imaging applications, the use of disposable sample containers can be advantageous in lowering the costs of analyzing a biological tissue sample. However, the imprecise manufacture and assembly of low cost, disposable sample containers can lead to variability in the location of the sample imaging surface, resulting in lower quality images of biological tissues samples and longer imaging times when adjusting a medical imaging system to a sample.

### SUMMARY

Embodiments described herein relate to a method and system for registering an imaging system to a sample container. In some embodiments, the system includes a sample container configured to support a biological tissue sample during imaging and an imaging system for generating optical images of the biological tissue sample. The sample container includes an imaging window having a top surface in contact with the biological tissue sample, corresponding to the sample imaging surface, and a bottom surface. The imaging system includes a scanning area configured to receive a portion of the sample container and an imaging device disposed below the scanning area. The imaging device is configured to emit a focused sample light signal towards the imaging window and to receive a reflected sample light signal from the imaging window. By moving the focal point of the sample light signal such that the focal point crosses the sample imaging surface and measuring the reflected sample light signal accordingly, the location of the sample imaging surface relative to the imaging device can be determined, thus registering the imaging device to the imaging window of the sample container.

### BRIEF DESCRIPTION OF THE DRAWINGS

FIG. 1 is a schematic illustration of an optical registration system, according to an embodiment.

FIG. 2 is a perspective view of the optical registration system detailing the imaging system and the sample container, according to an embodiment.

FIG. 3 is a cross-section view of the components of the imaging system and the sample container shown in FIG. 2.

FIG. 4 is a cross-section view corresponding to the inset A of FIG. 3 further detailing the components of the imaging system and the sample container.

FIG. 5 is a flow chart of a method of registering an imaging device to a sample container, according to an embodiment.

FIG. 6 is a schematic illustration of a sample container, according to an embodiment.

FIG. 7 shows an exploded view of a sample container, according to an embodiment.

FIG. 8 shows a cross-section of the sample container of FIG. 7.

### DETAILED DESCRIPTION

Embodiments described herein relate to a method and system for registering an imaging system to a sample container. In some embodiments, the system can include a sample container configured to support a biological tissue sample during imaging and an imaging system for generating optical images of the biological tissue sample. The sample container can include an imaging window having a top surface in contact with the biological tissue sample, which can correspond to the sample imaging surface, and a bottom surface. The imaging system includes a scanning area configured to receive a portion of the sample container and an imaging device disposed below the scanning area. The imaging device is configured to emit a focused sample light signal towards the imaging window and to receive a reflected sample light signal from the imaging window. By moving the focal point of the sample light signal such that the focal point crosses the sample imaging surface and measuring the reflected sample light signal accordingly, the location of the sample imaging surface relative to the imaging device can be determined, thus registering the imaging device to the imaging window of the sample container.

In medical imaging systems, disposable sample containers are often used to hold biological tissue samples for imaging and analysis in order to reduce costs. These sample containers are designed to hold a biological tissue sample to make handling of the biological tissue easier while reducing the risk of contamination and/or exposure. In some embodiments, the sample container encapsulates and immobilizes the tissue sample. In order to allow imaging of the sample in the sample container, the sample container can include an imaging window designed to interface with a medical imaging system. For example, a vacuum sealable sample container with an imaging window can be used with an optical coherence tomography (OCT) system as described in U.S. Patent Application No. U.S. 62/533,728 entitled, “Sample Container for Stabilizing and Aligning Excised Biological Tissue Samples for Ex Vivo Analysis”, filed on Jul. 18, 2017, and International Patent Application No. PCT/CA2018/050874 entitled “Sample Container for Stabilizing and Aligning Excised Biological Tissue Samples for Ex Vivo Analysis,” filed on Jul. 18, 2018, the disclosure of each of which is incorporated herein by reference in its entirety.

In some embodiments, the imaging window of the sample container is fabricated and assembled with loose tolerances to reduce costs. For medical imaging systems that provide high spatial resolution imaging at the micron level and a shallow depth of field, e.g., OCT systems, variability in the thickness and the placement of the imaging window in the medical imaging system can lead to greater difficulties when registering the medical imaging system to the sample. Registration refers to the process of aligning the focal point of the medical imaging system to the sample imaging surface, where the biological tissue sample contacts the imaging window, in order to acquire images of the sample at the highest spatial resolution. The present disclosure describes a method and system to register an imaging system to a sample container that compensates for the variability in the manufacture and assembly of the sample container.

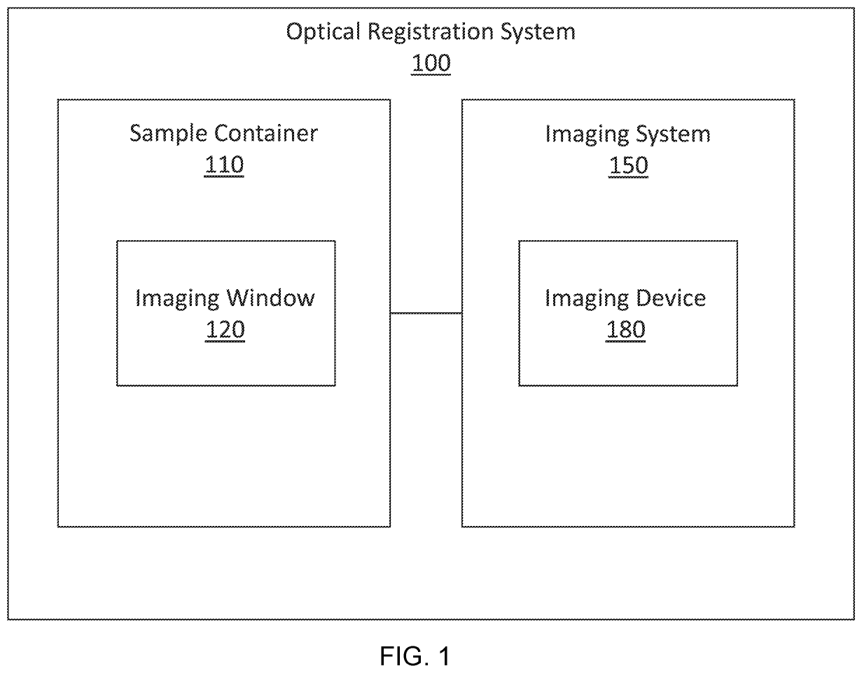

An exemplary embodiment of an optical registration system 100 is shown in FIG. 1. The optical registration system 100 includes a sample container 110. The sample container 110 is configured to support a biological tissue sample for transport and handling and includes an imaging window 120, which forms a portion of the sample container 110 supporting the biological tissue sample. The imaging window 120 is configured to be in contact with at least a portion of the biological tissue sample. To image the biological tissue sample, the sample container 110 is configured to interface with an imaging system 150 such that an imaging device 180, contained within the imaging system 150, can generate images of the biological tissue sample through the imaging window 120.

The sample container 110 can be used for handling and transport of a biological tissue sample in order to reduce contamination and exposure to a user and/or the ambient environment. In some embodiments, the sample container 110 includes an imaging window 120 to support at least a portion of the biological tissue sample. The sample container 110 can be configured to interface with the imaging system 150 such that the imaging device 180 can image the biological tissue sample through the imaging window 120 where the imaging window 120 is partially transparent to light emitted by the imaging device 180. The imaging window 120 includes a top surface (not shown) that contacts the biological tissue sample and a bottom surface (not shown) oriented towards the imaging system 150. The top surface of the imaging window 120 can correspond to the sample imaging surface. Thus, the registration of the imaging system 150 to the sample container 110 can be achieved by aligning the focal point of the imaging system 150 to the top surface.

In some embodiments, the imaging window 120 can be configured to be substantially planar. In other embodiments, the imaging window 120 can be configured to be concave, providing a depression or other such concavity such that the biological tissue is partially held in place during analysis and/or imaging. The imaging window 120 can have a thickness and lateral dimensions sufficient to withstand forces applied when handling, securing to the imaging system 150, or pumping air from the sample container 110 to create a vacuum. In some embodiments, the imaging window 120 can be various shapes, including, but not limited to, a circle, an ellipse, a square, and a rectangle.

In some embodiments, the imaging window 120 can include one or more registration features to facilitate registration between the imaging system 150 and the sample container 110. A registration feature can be used to mark a location on the imaging window 120 where registration should be performed. In some embodiments, the registration feature can be configured for detection by the imaging system 150, such as a recess or a protrusion that locally alters the thickness of the imaging window 120 and the location of the top surface or the bottom surface. In some embodiments, the registration feature can at least partially surround a region of space on the imaging window 120 where registration can be performed, e.g. a circular trench. Registration features can be disposed on the top surface or bottom surface of the imaging window 120. Multiple registration features can also be incorporated onto the imaging window 120. For example, a plurality of registration features spatially distributed across the imaging window 120 can be used to calibrate the curvature of a non-planar imaging window 120.

In some embodiments, the top surface and/or the bottom surface of the imaging window 120 can be coated with thin layers of material, which can modify the optical characteristics of the imaging window 120 to reduce errors or uncertainties when registering the imaging system 150 to the sample container 110. Generally, the bottom surface reflects a portion of the sample light signal (not shown) due to an optical impedance mismatch between the imaging window 120 and the surrounding air. Reflections can reduce the strength of the sample light signal on the top surface and contribute to systematic errors to the measured reflected sample light signal (not shown). In some embodiments, the bottom surface can be coated with an anti-reflection coating to reduce unwanted reflections from the bottom surface. The anti-reflection coating can be a thin film of material with a refractive index value ranging between the imaging window 120 and air, e.g., a refractive index value of 1.

The top surface can be coated with a thin film of material to increase reflections from the top surface. The coating on the top surface can also protect the top surface from contamination, e.g., the biological tissue sample, finger prints, dust, which can reduce the reflected sample light signal. The thin film of material can have a refractive index substantially different from the imaging window 120 to increase the optical impedance mismatch. Depending on the refractive index of the imaging window 120, the thin film can be made of a high index material, e.g., silicon, silicon nitride, or a low index material, e.g., low density polymer. In some embodiments, the coatings on the top surface and the bottom surface can be applied to cover a portion of the imaging window 120, e.g., regions where registration is performed.

The imaging window 120 can be formed from various materials with suitable strength, suitable rigidity, and sufficient transparency according to the spectrum of light emitted by the imaging device 180, including, but not limited to glass, borosilicate glass (e.g., Schott BK7 or H-K9L from CDGM Glass Company Ltd.), amorphous polyolefins, cyclo olefin polymers, cellulose acetate, high-density polyethylene, low-density polyethylene, high-impact polystyrene, polyetheretherketone, polyesters, polyvinyl chloride, polyvinylidene chloride, polypropylene, polyamides, acrylonitrile butadiene styrene, polyurethanes, poly(methyl methacrylate), polycarbonate, polyethylene, polyethylene terephthalate, polylactic acid, polyvinyl butyral, pyrex, nitrocellulose, acrylates, other materials disclosed herein, and combinations or mixtures of the materials listed.

As described above, the sample container 110 can be configured to interface with the imaging system 150 to facilitate imaging of the biological tissue sample through the imaging window 120. In some embodiments, the sample container 110 can be an imaging window 120. For example, the sample container 110 can be a glass slide or a petri dish configured to rest on a frame (not shown) in the imaging system 150. In other embodiments, the imaging window 120 can include protrusions or recesses along the periphery that mate with corresponding recesses or protrusions on the frame of the imaging system 150 to restrict the lateral motion of the sample container 110.

In some embodiments, the sample container 110 can include a positioning member (not shown) coupled to the imaging window 120, where the positioning member is configured to couple to the frame of the imaging system 150. The positioning member can include an aperture configured to mate with the imaging window 120 such that the periphery of the imaging window 120 is mechanically supported by the positioning member and the central portion of the imaging window 120 is substantially suspended. In some embodiments, a gasket can be placed between the imaging window 120 and the positioning member to form an airtight seal. The positioning member can couple to the frame using various types of connection methods, including, but not limited to, a twist and lock mechanism, one or more screw fasteners with corresponding holes, a pair of threaded connectors, and a pair of magnets. In some embodiments, the positioning member can further include one or more alignment features, e.g., a protrusion configured to fit into a recess on the frame, to facilitate alignment of the sample container 110 to the imaging system 150. Alignment features can also include, but are not limited to, alignment markings, fiducial marks, protuberances, keys, mechanical stops, and recesses.

In some embodiments, the sample container 110 can also include a sample bag (not shown) configured to contain a biological tissue sample. The sample bag can be used to form an enclosure, thus isolating the biological tissue sample from the ambient environment. In some embodiments, the sample bag can couple to a sealing member (not shown), where the sealing member is configured to couple to the positioning member. The combination of the sample bag, the sealing member, the positioning member, and the imaging window 120 forms an enclosure. The sample bag can be coupled to the sealing member using various types of connection methods including, but not limited to an adhesive, thermal bonding, a thermal fusing process, thermochemical melding, and thermal or mechanical forming where the sample bag and the sealing member are formed from a single part. The sealing member can couple to the positioning member using various types of connection methods, including, but not limited to, a twist and lock mechanism, one or more screw fasteners and corresponding holes, a pair of threaded connectors, and a pair of magnets.

In some embodiments, the sealing member can form an airtight seal with the positioning member to better isolate the biological tissue sample from the surrounding environment. The airtight seal can also allow the sample container 110 to be subjected to a vacuum. A vacuum can be applied to draw the sample bag around the biological tissue sample such that the sample bag secures and spreads the biological tissue sample against the imaging window 120. In some embodiments, the sample bag can be formed from a flexible, vacuum compatible material. In some embodiments, the positioning member can include a vacuum port coupled to a vacuum pump in the imaging system 150 to allow air to be drawn out of the interior cavity of the sample container 110.

In some embodiments, the frame can be used as a support structure to mechanically couple to various components in the imaging system 150, such as the imaging device 180, various electronics, power supply systems, and computer systems. In some embodiments, the frame can include a top plate (e.g., a first plate) (not shown), side members (not shown), and a base plate (e.g., a second plate) (not shown), the assembly of which forms a cavity between the base plate and the top plate. The base plate can couple to the imaging device 180 with the imaging device 180 disposed in the cavity formed by the frame. The top plate can be configured to couple to the sample container 110.

The top plate of the frame can include a primary aperture (not shown) configured to align concentrically with the imaging window 120 of a sample container 110. The primary aperture can be used to define the portion of the imaging window 120 where images of the biological tissue sample can be taken by the imaging system 150. In some embodiments, the primary aperture can have lateral dimensions smaller than the suspended portion of the imaging window 120 to ensure the sample container 110 cannot fall through the primary aperture. In some embodiments, the top plate can also include a secondary aperture (not shown). The secondary aperture can be used to image a portion of the imaging window 120 reserved for registration. The secondary aperture can be positioned near the edge of the imaging window 120 where the top surface is more likely to remain pristine, e.g., the biological tissue sample is less likely to spread to the periphery of the imaging window 120 and contaminate the top surface during registration. In some embodiments, multiple secondary apertures can be positioned on the top plate to provide multiple locations to perform registration. The combination of the primary aperture and the secondary aperture thus defines the scanning area (not shown) used for imaging of the biological tissues sample and for registration.

As described above, the imaging window 120 or the positioning member of the sample container 110 can be configured to couple to the frame. The frame can thus include various types of corresponding connectors to couple to the sample container 110, including, but not limited to, a twist and lock mechanism, one or more screw fasteners and corresponding holes, a pair of threaded connectors, and a pair of magnets. The frame can also include corresponding alignment features configured to mate with alignment features on the sample container 110, including, but not limited to, alignment markings, fiducial marks, protuberances, keys, mechanical stops, and recesses.

The imaging device 180 can include a light source that emits light towards the sample, e.g., the sample light signal, and a detector configured to receive and detect light reflected from the sample, e.g., the reflected sample light signal. In some embodiments, the imaging device 180 can be an OCT system, which can provide both two-dimensional and three-dimensional imaging modalities with micron imaging resolution and a shallow depth of field. The light source can be a narrowband source, e.g., a laser, or a broadband source, e.g., a white light lamp. The light source can also be configured to emit light at various wavelengths to facilitate imaging of a sample, e.g., visible, near-infrared, and mid-infrared light. The imaging device 180 can also include optical elements, e.g., a lens, a collimator, to focus light emitted by the light source onto the sample to improve the image resolution. The detector can be various types of light detectors including, but not limited to, a single photodiode in combination with a scanning system, a charge-coupled device (CCD) camera, and an array of photodiodes forming a camera. In some embodiments, the imaging device 180 can also include an interferometer configured to reduce the depth of focus of the sample light signal, thus improving the depth resolution of the imaging device 180.

The focal point of the sample light signal, e.g., the distance between the imaging device 180 and the position where the spot size of the sample light signal is smallest, can be moved along the optical axis of the imaging device 180. In some embodiments, an optical element, e.g., a lens, can be coupled to a positioning element (e.g., motor) in the imaging device 180, which can move the focal point such that the biological tissue sample and/or the imaging window 120 moves in or out of focus. In some embodiments, the imaging device 180, including the light source, optical elements, and detector, can be coupled to a motor to move the focal point. A combination of one or more motors can also be used to provide coarse and fine adjustment of the focal point position. In some embodiments, adjustments to the focal point position can be coupled to adjustments in an interferometer in the imaging device 180 to maintain a depth of focus as the focal point is moved.

The biological tissue sample can reflect a portion of the sample light signal diffusely while the imaging window 120 can specularly reflect the sample light signal. The specular reflection from the imaging window 120 can cause image saturation causing the features on the sample to become obscured. In some embodiments, the imaging device 180 can be rotated such that the optical axis of the imaging device 180 illuminates the imaging window 120 at a small angle of incidence. The detector in the imaging device 180 can then be positioned to substantially receive light reflected diffusely from the sample while reducing the amount of light received from specular reflections from the imaging window 120. However, the detector should be configured to receive at least a portion of light specularly reflected from the imaging window 120 to facilitate an optical registration process. In some embodiments, the imaging device 180 can be rigidly coupled to have a rotated orientation during image acquisition and registration. In some embodiments, the imaging device 180 can be coupled to a motor, which can adjust the orientation of the imaging device 180 relative to the imaging window 120 to control the portion of specularly reflected light received from the imaging window 120.

In some embodiments, the imaging device 180 can be coupled to a motion control system (not shown) to facilitate scanning of the biological tissue sample along the scanning area. The motion control system can include one or more axes of motion configured to scan a two-dimensional area where each axis of motion can be controlled by at least one motor. For example, the motion control system can include a first linear translation stage coupled to the base plate and configured to move along one axis of the scanning area. A second linear translation stage can be coupled to the first linear translation stage and configured to move along another axis of the scanning area that is substantially orthogonal to the axis of motion of the first linear translation stage. The motion control system can have a range of motion that covers the scanning area and a spatial resolution smaller than the field of view of the imaging device 180 such that images acquired over a large scanning area can be stitched together. The motion control system can support a separate motor configured to adjust the focal point of the imaging device 180, as described above. In some embodiments, the imaging device 180 can be rigidly coupled to the frame with the motion control system coupled to the sample container 110 to facilitate scanning of the biological tissue sample.

In embodiments where the sample container 110 includes a sample bag, a continuous vacuum system (not shown) can be used to draw air out of the interior cavity of the sample container 110. The vacuum system can include tubing or piping that couples to the sample container 110 via a vacuum port on the positioning member. In some embodiments, the continuous vacuum system can include a pump, e.g., an oil pump, a scroll pump, installed separately in the environment to reduce vibrational noise that can emanate from the pump. The continuous vacuum system can be configured to remain deactivated until the sample container 110 is placed onto the imaging system 150, after which one or more sensors, e.g., a magnetic alignment device in communication with a processor, can trigger the continuous vacuum system to activate, thus pumping air from the sample container 110.

In some embodiments, systems, methods, and devices for registering an imaging device to an imaging window of a sample container can be implemented using a processor (e.g., a processor integrated into an imaging system or a remote processor operatively coupled to the imaging system). The processor can be any suitable processing device configured to run and/or execute functions associated with registering an imaging device to an imaging window of a sample container. For example, the processor can be configured to control the imaging device to emit a light signal toward an imaging window, receive data associated with a reflected light signal, analyze the received data to identify a relative location of a sample imaging surface (e.g., a surface of the imaging window in contact with a biological tissue sample), adjust a location of the imaging device relative to the sample imaging surface based on the received data (e.g., by controlling the movement of one or more motors and/or positioning elements to move the imaging device along and/or about one or more axes), and/or present information to a user (e.g., via a user interface) associated with registering the imaging device. In some embodiments, the processor can be a general purpose processor, a Field Programmable Gate Array (FPGA), an Application Specific Integrated Circuit (ASIC), a Digital Signal Processor (DSP), and/or the like.

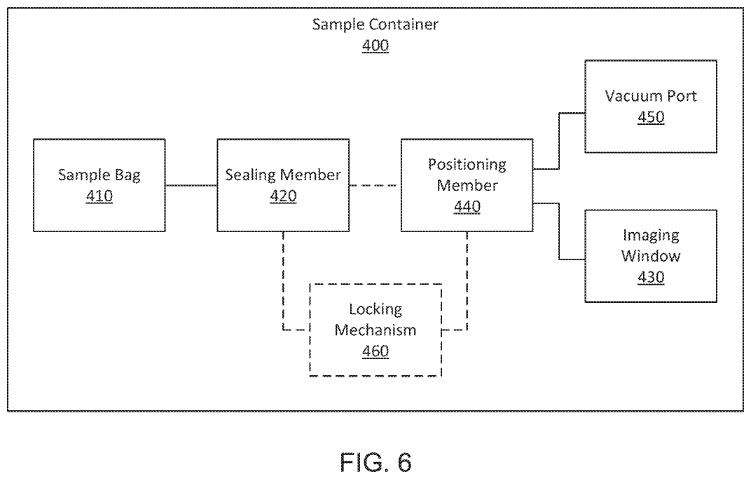

FIG. 6 shows a schematic illustration of a sample container 400 that provides a more detailed view of portions and/or aspects of a sample container. The sample container 400 can include portions and/or aspects that are substantially similar in form and/or function to corresponding potions and/or aspects of sample container 110, described above with reference to FIG. 1. For example, the sample container 400 includes a sample bag 410 defining an inner volume configured to receive the biological tissue sample (not shown), and a sealing member 420 coupled to the sample bag 410. In some embodiments, an imaging window 430 is disposed and configured to be placed in contact with at least a portion of the biological sample.

In some embodiments, a positioning member 440 is coupled to the imaging window 430 and is configured to be disposed against the sealing member 420 to substantially seal the inner volume of the sample bag 410. In some embodiments, the positioning member 440 can include at least one vacuum port 450 disposed and configured to be aligned with a vacuum source to withdraw air from the inner volume of the sample bag 410. In some embodiments, the sample container 400 further includes a locking mechanism 460 configured to selectively engage with at least one of the positioning member 440 and/or the sealing member 420.

In some embodiments, the sample bag 410 is dimensioned and configured to hold or contain the biological tissue sample) during analysis and/or for a period of time after analysis has been conducted. In some embodiments, the sample bag 410 is dimensioned and configured to hold or contain the biological tissue sample for an extended period of time, during which time the sample is stored and/or transported for additional analysis and/or imaging. In some embodiments, the sample bag 410 is dimensioned and configured to be in a first configuration in which the inner volume of the sample bag 410 is at or is substantially at a maximum. In some embodiments, the biological tissue sample can be disposed within the sample bag 410 when the sample bag 410 is in the first configuration. In some embodiments, withdrawing air from the sample bag 410 can transition the sample bag 410 from the first configuration to a second configuration in which the inner volume of the sample bag 410 is lower than in the first configuration. In some embodiments, once a portion of air is withdrawn from the sample bag 410, the inner volume of the sample bag 410 can be substantially similar to the volume of the biological tissue sample. In some embodiments, the portion of air removed from the sample bag 410 can create a partial vacuum within the sample bag 410. In some embodiments, when the sample bag 410 is in the second configuration, the sample bag 410 can hold the biological tissue sample in place against the imaging window 430.

In some embodiments, the sample bag 410 can be coupled to the sealing member 420. In some embodiments, the sample bag 410 can be coupled to the sealing member 420 by interposing a portion of the sample bag 410 between two or more portions (e.g., layers) of the sealing member 420. For example, the two portions or more of the sealing member 420 can be coupled mechanically, with an adhesive, thermally bonded, or any combination thereof. In some embodiments, the sample bag 410 can be coupled to the sealing member with an adhesive. In some embodiments, the sample bag 410 can be coupled to the sealing member 420 through a thermal fusing process. In some embodiments, the sample bag 410 can be coupled to the sealing member 420 through a thermochemical melding of the two materials. In some embodiments, the sample bag 410 can be formed from the sealing member 420. In some embodiments, the sample bag 410 can be formed by extruding the sealing member 420 with no center hole and then forming the sample bag 410 from the sealing member 420 through thermal and/or physical deformation (e.g., stretching) of a portion of the sealing member 420. In some embodiments, deformation of a portion of the sealing member 420 (e.g., in the center) can define an aperture of the sealing member 420 and the opening of the sample bag 410. In some embodiments, the deformed portion of the sealing member 420 can be deformed to form the sample bag 1410 therefrom. In some embodiments, the portion (e.g., center) of the sealing member 420 can be deformed to the extent that the material becomes sufficiently elastic and/or deformable and such that the formed sample bag 410 can transition from the first configuration to the second configuration when air is withdrawn from the sample bag 410.

In some embodiments, the sample bag 410 maintains a first configuration when no vacuum is drawn against the sample container 400. In some embodiments, the sample bag 410 can be substantially extended to its most voluminous state in the first configuration. In other words, the inner volume of the sample bag 410 is at or near a maximum volume in the first configuration. In some embodiments, once vacuum is drawn on the sample container 400 by withdrawing air from the sample bag 410, the sample bag 410 can transition from the first configuration to a second configuration. In some embodiments, the inner volume of the sample bag 410 in the second configuration is less than the inner volume of the sample bag 410 in the first configuration. In some embodiments, the inner volume of the sample bag 410 in the second configuration can be substantially similar to the volume of the biological tissue sample. Said another way, once vacuum is drawn on the sample container 400 substantially all of the air is removed from the inner volume of the sample bag 410 such that the biological tissue sample occupies nearly 100% of the inner volume. In some embodiments, the sample bag 410 can transition to a third configuration once the vacuum system is disconnected from the sample container 400 or the partial vacuum is otherwise relieved. In some embodiments, the sample bag 410 can transition to the third configuration while the vacuum system is still connected and the sample container 400 remains under partial vacuum. In some embodiments, the inner volume of the sample bag 410 in the third configuration can be less than the inner volume of the sample bag 410 in the first configuration but greater than the inner volume of the sample bag 410 in the second configuration. In some embodiments, the sample bag 410 can move from the second configuration back to substantially the first configuration once the sample container 400 is disconnected from the vacuum system or air is otherwise communicated back into the sample bag 410. In some embodiments, the sample bag 410 can remain substantially in the second configuration once the sample container 400 is disconnected from the vacuum system or air is otherwise communicated back into the sample bag 4110. In some embodiments, the sample bag 410 can remain substantially in the second configuration because the vacuum port 450 can be sealed closed such that air is not allowed to be communicated back in to the sample bag 410. In some embodiments, sealing the vacuum port 450 can allow for the movement of the sample container 400 between different imaging devices and/or can allow the biological tissue sample to be stored in the sample container 400 without becoming contaminated.

The sealing member 420 can be a gasket, the gasket coupled to the sample bag 410 such that a seal is formed between the sample bag 410 and the sealing member 420. In some embodiments, the sealing member 420 can be disposed against a surface to form a seal. In some embodiments, the sealing member 420 can be disposed between two surfaces in order to substantially seal the sample container 400. In some embodiments, the sealing member 420 can define a center hole (not shown). In some embodiments, the sealing member 420 can be placed into abutment with a surface of the positioning member 440 during use of the sample container 400. In some embodiments, the abutment of the sealing member 420 against the surface of the positioning member 440 creates a seal or partial seal between the inner volume of the sample bag 410 and the outside environment. In some embodiments, the positioning member 440 is connected to the sealing member 420 to form a releasable seal between a surface of the sealing member 1420 and the surface of the positioning member 440. In some embodiments, the positioning member 440 is interposed between the sealing member 420 and the imaging device or aperture defined therein. In some embodiments, the sealing member 420 is interposed between the positioning member 440 and the imaging device or aperture defined therein. In some embodiments, the sealing member 420 substantially covers a top portion or top side of the positioning member 440.

The imaging window 430 at least partially defines the inner volume of the sample container 400 along with the sample bag 410, and is configured to be placed against an imaging device such that the imaging device can take images of the biological sample through the imaging window 430. In some embodiments, the imaging window 430 can be configured to be placed in contact with at least a portion of the biological tissue sample. In some embodiments, the imaging window 430 can be dimensioned and configured to be planar. In some embodiments, the imaging window 430 can be dimensioned and configured to be concave, providing a depression or other such concavity that at least partially holds the biological tissue sample in place during analysis and/or imaging. In some embodiments, the imaging window 430 can be fixedly coupled to the positioning member 440. In some embodiments, the imaging window 430 can be removably coupled to the positioning member 440. In some embodiments, the imaging window 430 can be disposed within an aperture (not shown) defined by the positioning member 440. In some embodiments, the imaging window 430 can be formed from the same material and/or at the same time as the positioning member 440. In other words, the imaging window 130 can be non-delineable element of the positioning member 440 (i.e., integrally formed with the positioning member 440).

In some embodiments, the imaging window 430 can have a thickness sufficient to withstand any vacuum pressure disclosed herein. In some embodiments, the imaging window 130 can be thin enough so as to allow light particles, electromagnetic energy, or other energy forms to pass through the imaging window 430. In some embodiments, the thickness of the imaging window 430 can be between about 10 μm and about 15 mm, between about 250 μm and about 13 mm, between about 500 μm and about 10 mm, between about 750 μm and about 9 mm, between about 850 μm and about 8 mm, between about 1 mm and about 7 mm, between about 1 mm and about 6 mm, between about 1.5 mm and about 5 mm, and between about 2 mm and about 4 mm, inclusive of all ranges and values therebetween. In some embodiments, the thickness of the imaging window 430 can be greater than about 10 μm, greater than about 50 μm, greater than about 100 μm, greater than about 250 μm, greater than about 500 μm, greater than about 750 μm, greater than about 1 mm, greater than about 3 mm, greater than about 5 mm, greater than about 7 mm, greater than about 9 mm, greater than about 11 mm, greater than about 13 mm, or greater than about 15 mm, inclusive of all ranges and values therebetween.

In some embodiments, the imaging window 430 can be made from any suitably rigid, suitably strong, and suitably transparent material. In some embodiments, the imaging window 130 can be made of glass, borosilicate glass (e.g., Schott BK7 or H-K9L from CDGM Glass Company Ltd.), amorphous polyolefins, cyclo olefin polymers, cellulose acetate, high-density polyethylene, low-density polyethylene, high-impact polystyrene, polyetheretherketone, polyesters, polyvinyl chloride, polyvinylidene chloride, polypropylene, polyamides, acrylonitrile butadiene styrene, polyurethanes, poly(methyl methacrylate), polycarbonate, polyethylene, polyethylene terephthalate, polylactic acid, polyvinyl butyral, pyrex, nitrocellulose, acrylates, any other material disclosed herein, and any other material suitably transparent and durable to enable imaging/analysis while also withstanding partial vacuum conditions, and combinations or admixtures thereof.

In some embodiments, the thickness of the imaging window 430 can vary, e.g., depending on a specific application and/or material used for the imaging window 430. For example, the thickness of the imaging window 430 can vary depending on whether the sample container 400 is used with a specific size or volume of tissue and/or a type of tissue, or whether the sample container 400 is used with or without a vacuum. The thickness of the imaging window 430 can affect accurate analysis and/or imaging. Systems, methods, and devices described herein provide for registration of an imaging device (e.g., imaging device 180) with a sample imaging surface that compensates for the variability of the thickness of the imaging window 430.

As described herein, the positioning member 440 can be coupled to and/or integrally formed with the imaging window 430. In some embodiments, the positioning member 140 can be non-uniformly shaped and the sealing member 420 can be dimensioned and configured such that the abutment of the sealing member 420 against the positioning member 440 can result in the sample container 400 being substantially sealed.

In some embodiments, the shape of the positioning member 440 can be in the form of a torus, hemisphere, disk, hoop, ring, halo, circle, planar circle, cuboid, ellipsoid, sphere, cylinder, hexagonal prism, pentagonal prism, rhombus, frustum, irregular polygon, any other suitable shape, or combinations thereof. In some embodiments, the positioning member 440 defines the aperture approximately in the center of the positioning member 440, and the imaging window 430 is disposed within the aperture defined by the positioning member 440. In some embodiments, the imaging window 430 is coupled to the positioning member 440 such that a substantially airtight seal is formed. In some embodiments, the positioning member 440, the imaging window 430, the sealing member 420, and the sample bag 410 collectively define the inner volume in which the biological sample is disposed.

In some embodiments, the positioning member 440 can be dimensioned and configured to abut a portion of an imaging device. In some embodiments, the positioning member 440 can be configured to position the sample of biological tissue in three-dimensional space relative to a lens or probe of the imaging device. In some embodiments, the positioning member 440 can be disposed at least partially within a recess of the imaging device. In some embodiments, the positioning member 440 can include an alignment feature to help ensure the sample container 400 is properly positioned with respect to the imaging device. For example, in some embodiments, the positioning member 440 can include alignment markings, fiducial marks, protuberances, keys, mechanical stops, recesses and/or the like that are designed to mate with the imaging device so that the sample container 400 is properly positioned with respect to the imaging device. Similarly, the imaging device can include alignment markings, fiducial marks, protuberances, keys, mechanical stops, recesses and/or the like that are designed to mate with the sample container 400. In other words, either the sample container 400, the imaging device, or both can include alignment features to help ensure the sample container 400 is properly positioned with respect to the imaging device.

In some embodiments, the positioning member 440 can have an outer surface and an inner surface. In some embodiments, the inner surface of the positioning member 440 can define a groove or a plurality of grooves. In some embodiments, the groove can be substantially filled with a plurality of indents. In some embodiments, the inner surface of the positioning member 440 can include threads. In some embodiments, the threads on the inner surface of the positioning member 440 can be dimensioned and configured to engage receiving threads within an aperture of the imaging device.

The vacuum port 450 is dimensioned and configured to be aligned with (i.e., placed in fluid communication) a vacuum source (not shown), such that the vacuum source can draw at least a partial vacuum on the sample container 400. Said another way, when the vacuum port 450 is aligned with the vacuum source, air can be drawn out of the sample bag 410 via the vacuum port. In some embodiments, the vacuum source can be a part of the imaging device. In some embodiments, the vacuum port 450 can be used to releasably couple the sample container 400 to the imaging device via the vacuum system as the vacuum system draws a partial vacuum on the sample container 400 such that the sample bag 410 is drawn around the biological tissue sample to hold it in place against the imaging window 430 during imaging/analysis.

In some embodiments, the vacuum port 450 can be disposed within the positioning member 440. In some embodiments, the vacuum port 450 can be a single vacuum port. In some embodiments, the vacuum port 450 can be a plurality of vacuum ports. In some embodiments, the plurality of vacuum ports 450 can be between two and ten, between two and eight, between two and six, between two and five, between two and four, between two and three, greater than two, greater than four, greater than six, greater than eight, or greater than 10, inclusive of all ranges and value therebetween.

In some embodiments, drawing vacuum on the sample container 400 results in the sample bag 410 being drawn tightly around the biological tissue sample, holding the biological tissue sample substantially immovably on the imaging window 430. In some embodiments, the biological tissue sample is held substantially immovably in a particular positon by both the positioning member 1440 being releasably locked with respect to the imaging device (i.e., within an aperture) using the locking mechanism 460, and the air within the inner volume of the sample bag 410 being substantially evacuated from the inner volume.

In some embodiments, the locking mechanism 460 can be coupled to at least one of the positioning member 440 and/or the sealing member 420. In some embodiments, the locking mechanism 460 can be coupled to both the positioning member 440 and the sealing member 420. In some embodiments, the locking mechanism 460 can be coupled to both the positioning member 440 and the imaging device. In some embodiments, the locking mechanism 460 is configured to lock the positioning member 440 against the imaging device. In some embodiments, the locking mechanism 460 is configured to lock the positioning member 440 in an aperture of the imaging device. In some embodiments, the locking mechanism 460 is disposed between the two portions of the positioning member 440 such that the two portions of the positioning member 440 can be locked together. In some embodiments, the locking mechanism 460 is disposed between the two portions of the positioning member 440, such that the sealing member 420 can be interposed between the two portions of the positioning member. In some embodiments, the locking mechanism 460 can be configured such that the positioning member 440 can be immovably connected to at least a portion of the sealing member 420.

In some embodiments, the locking mechanism 460 can be a first threaded element dimensioned and configured to rotationally engage with a second threaded element. In some embodiments, the first and/or second threaded element can include stops or extents. In some embodiments, the stops or extents can be a physical barrier at a precise point which halts further rotational and vertical motion of the positioning member 440.

In some embodiments, the locking mechanism 460 can be a feature of the sample container 400 that is separate and distinct from the positioning member 440. In some embodiments, the locking mechanism 460 can be a locking pin or bolt. In some embodiments, the locking mechanism 460 can be a strap. In some embodiments, the locking mechanism 460 can be a latch. In some embodiments, the locking mechanism 460 can be spring-loaded detents that are disposed within a depression once the positioning member 440 is appropriately positioned on a surface of the imaging device or within the aperture in a surface of the imaging device. In some embodiments, the locking mechanism 460 can include any combination of the features and elements included herein.

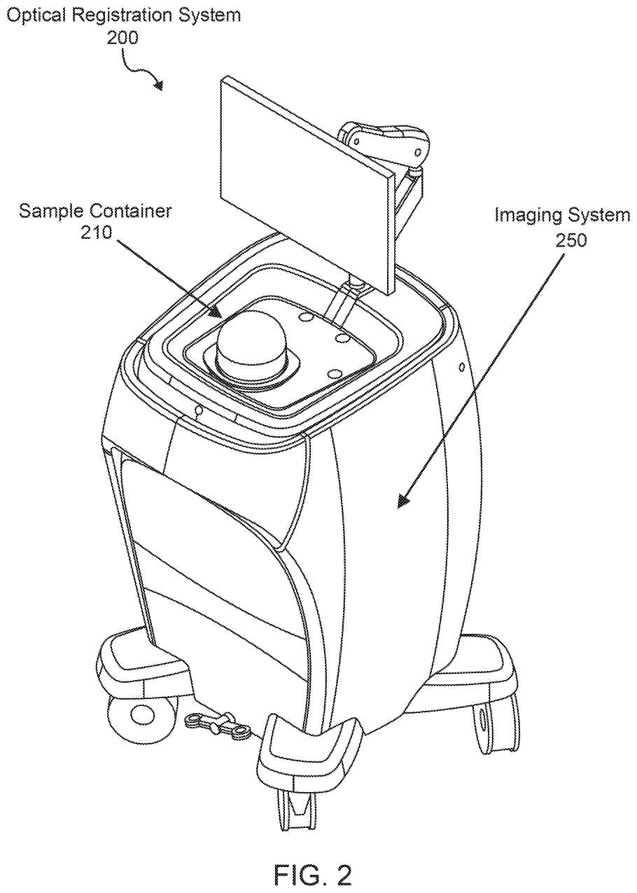

FIGS. 2-4 show an embodiment of an optical registration system 200. In some embodiments, portions and/or aspects of the optical registration system 200 are substantially similar in form and/or function to the corresponding portions and/or aspects of the optical registration system 200 described above with reference to FIG. 1. For example, optical registration system 200 can include a sample container 210 and an imaging system 250.

The sample container 210 can be configured to hold a biological tissue sample, e.g., during transport, during analysis, and/or for a period of time after analysis has been conducted. The sample container 210 can include portions and/or aspects that are substantially similar to sample containers 110 and/or 400, as described above with reference to FIGS. 1 and 6. As shown, the sample container 210 includes a sample bag 240 to contain a biological tissue sample.

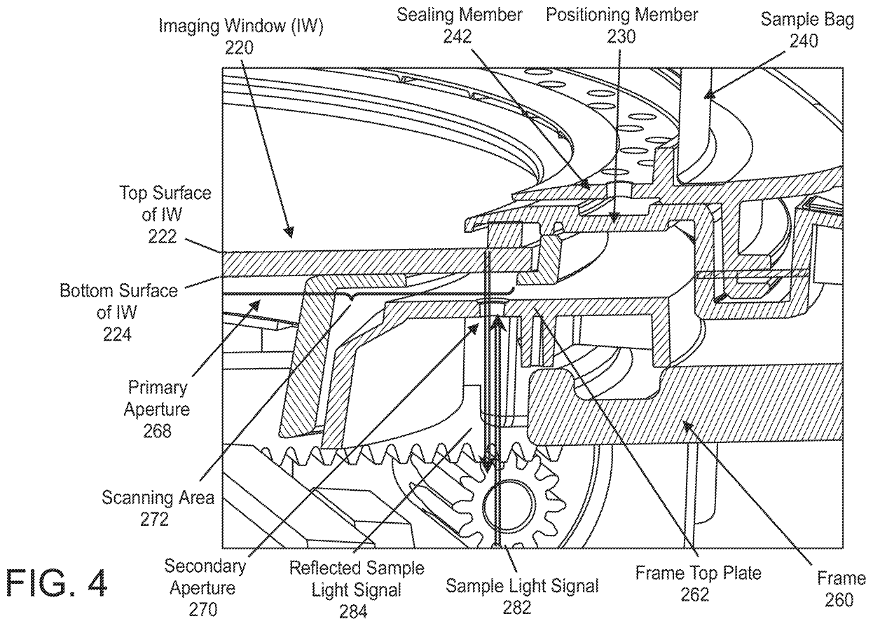

The sample container 210 can be configured to interface with the imaging system 250 to facilitate imaging of the biological tissue sample. For example, the sample container 210 includes an imaging window 220 that can be placed concentrically onto a primary aperture 268 on a frame 260 of the imaging system 250. In some embodiments, the sample container 210 can be configured to be connected to the imaging system 250, e.g., via a positioning member 230, as described in further detail below with reference to FIG. 4.

The imaging system 250 includes an imaging device 280 located below the primary aperture 268 and oriented to emit and receive light from the imaging window 220 through the primary aperture 268. The imaging device 280 is positioned at an angle relative to the imaging window 220 (e.g., positioned and/or rotated to have a slight probe angle such that light emitted by the imaging device 280 contacts a surface of the imaging window 220 at an angle of incidence that is less than)90° to reduce detection of specularly reflected light from the imaging window 220. The imaging device 280 is also coupled to a motion control system 288, which includes two axes of motion arranged to move the imaging device 280 along the imaging window 220.

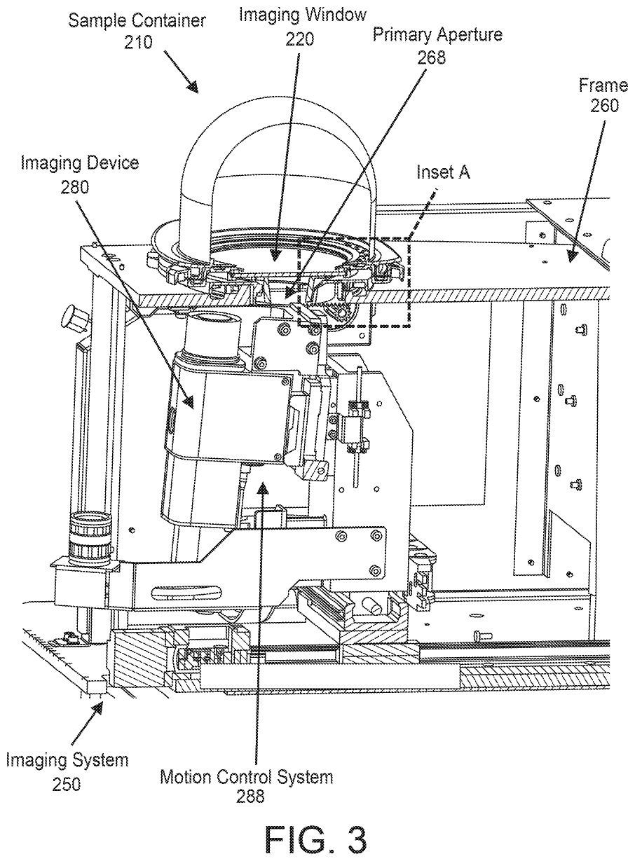

FIG. 4 provides a more detailed, cross-sectional view of an area identified as inset A in FIG. 3. As shown in FIG. 4, the imaging window 220 includes a top surface 222 (e.g., a first surface) that contacts the biological tissue sample and a bottom surface 224 (e.g., a second surface) oriented towards the imaging system 250. The imaging window 220 is supported along the periphery by a positioning member 230 with a sealing member 242 (e.g., gasket) to ensure an air tight seal. The sealing member 242 is included to couple the sample bag 240 to the positioning member 230, thus forming an enclosure around a sample.

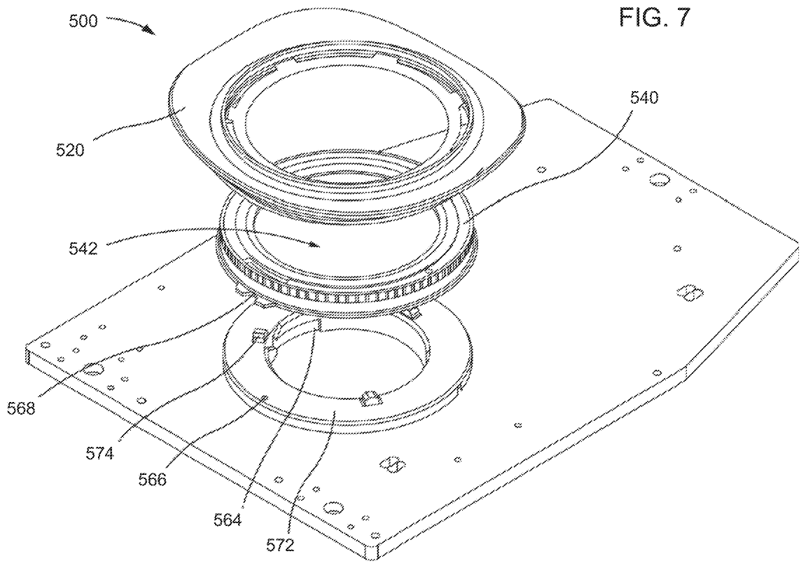

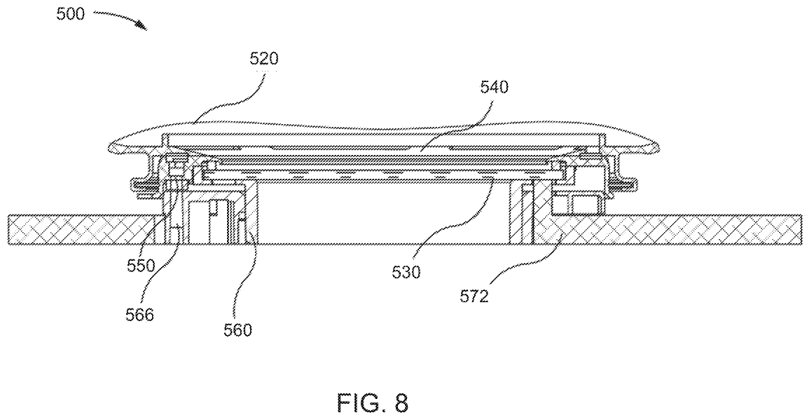

The positioning member 230 is configured to couple to the frame 260 of the imaging system 250. The positioning member can couple to the frame using various types of connection methods, including, but not limited to, a twist and lock mechanism, one or more screw fasteners with corresponding holes, a pair of threaded connectors, and a pair of magnets. In some embodiments, the positioning member can further include one or more alignment features, e.g., a protrusion configured to fit into a recess on the frame, to facilitate alignment of the sample container 210 to the imaging system 250. Alignment features can also include, but are not limited to, alignment markings, fiducial marks, protuberances, keys, mechanical stops, and recesses. For example, FIGS. 7 and 8 depict a sample container 500 including portions and/or aspects for coupling to an imaging system. The sample container 500 includes a sealing member 520, an imaging window 530, a positioning member 540, and a sample bag (not shown to more clearly convey the connection between the sealing member 520, the positioning member 540, and an imaging system).

The sample container 500 can be configured to be connected to an imaging device of an imaging system. In some embodiments, the imaging device includes a receiving member 572 (e.g., integrated into and/or coupled to a frame of the imaging device) dimensioned and configured to receive at least a portion of the sample container 500. In some embodiments, the receiving member 572 includes a channel 564 configured to receive a portion of the positioning member 540 in order to aid a user (not shown) in locking the positioning member 540 to the imaging device. In some embodiments, the receiving member 572 can include stops 574 that are dimensioned and configured to terminate rotation of the positioning member 540. In some embodiments, the stops 574 can be magnetized and/or electrically connected to an alignment monitoring system (not shown) which notifies the user when the stops 574 are contacted. In some embodiments, the alignment monitoring system is in communication with the vacuum system such that, once alignment is confirmed by the alignment monitoring system, the vacuum system is initiated and air is withdrawn from the sample bag, drawing the sample bag around a biological tissue sample (not shown).

In some embodiments, the positioning member 540 can include an alignment feature 568 that provides the user with a visual indication of alignment of the positioning member 540 with regard to the imaging device. In some embodiments, the alignment feature 568 is a tab that protrudes radially outward from the center of the positioning member 540 which indicates alignment of a vacuum port 550 with the vacuum system port 566.

In some embodiments, the sample container 500 can further include a locking mechanism 560 that holds the positioning member 540 in proper position, as shown in FIG. 8. Proper alignment of the positioning member 540 with respect to the imaging device can result in the vacuum port 550 being properly aligned above the vacuum system port 566, with very little or no clearance between the two ports. In some embodiments, the rotation of the positioning member 540 causes the engagement of the locking mechanism 560. In some embodiments, engaging the locking mechanism 560 moves the positioning member 540 closer towards the receiving member 572, causing the vertical gap between the vacuum port 550 and the vacuum system port 566 to close. This can help form a tight seal between the vacuum port 550 and vacuum system port 566 such that the vacuum system can better withdraw air from the sample bag.

For many imaging and/or analysis techniques, a biological tissue sample should be positioned very precisely to facilitate accurate analysis/imaging. For instance, OCT imaging uses near-infrared light to produce high-resolution images of various objects such as, but not limited to tissue, for example. When OCT imaging is used on tissue, it is analogous to high-frequency ultrasound, except that the optical interferometry of OCT imaging is used for depth ranging rather than echo timing. OCT imaging is rapid, non-contact, non-invasive, and capable of generating 2D and 3D images at high resolution (˜10 μm). In OCT imaging, the registration of an imaging window of a sample container (e.g., sample containers 110, 210, 400, 500) can be important because the OCT image has micron level resolution and a shallow depth of field. This means the imaging window should be positioned with a high level of accuracy relative to the imaging plane. Therefore, as described herein, in some embodiments, the sample container and/or the imaging device can include spacers and/or raised surfaces that result in the imaging window being placed into a precise position once disposed in the imaging device.

In addition, for many of the imaging and/or analysis techniques typically used to examine the excised biological tissue sample, the biological tissue sample should remain substantially motionless during the analysis/imaging period. After excitation of the biological tissue sample, especially if the tissue sample is not cleaned and/or dried before analysis, can be quite slippery and therefore difficult to handle during imaging and/or analysis. A practitioner holding the biological tissue sample can often find it difficult to keep the sample in a particular location during imaging and/or analysis. The use of compression plates to hold the excised biological tissue sample in place for imaging and/or analysis has been tried, however, the flat surface of the compression plates are typically unable to contain the slippery specimen. Therefore, it can be especially important to have a particularly contoured surface that contacts and holds the biological tissue sample in place during analysis/imaging. A molded contact surface, however, is molded for a particular excised biological tissue sample and may not be useful for specimens of different size and/or shape. Therefore, using a sample bag as described herein as a contacting surface for the biological tissue sample can increase the ease with which the biological tissue sample is held substantially motionless during analysis/imaging.

Differences in the configuration of a sample container (e.g., a thickness and/or shape of an imaging window) and/or placement of a tissue sample relative to an imaging device can lead to difficulties in registering the imaging device to the tissue sample. Systems, methods, and devices described herein enable registration of an imaging system to a sample container that compensates for these differences.

For example, as depicted in FIG. 4, in order to register the imaging system 250 to the imaging window 220, the top plate 262 of the frame 260 includes a secondary aperture 270 positioned near the edge of the imaging window 220, e.g., where the top surface 222 is more likely to remain clean or uncontaminated by the biological tissue sample. The combination of secondary aperture 270 and the primary aperture 268 defines the sample scanning area 272, e.g., used for imaging of the biological tissue sample and for registration. During registration, the imaging device 280 emits a sample light signal 282 through the secondary aperture 270 and receives a reflected sample light signal 284. As described above, by measuring the reflected sample light signal 284 accordingly, the location of a sample imaging surface (i.e., the top surface 222 of the imaging window 220) relative to the imaging device 280 can be determined, thus registering the imaging device 280 to the imaging window 220 of the sample container 210.

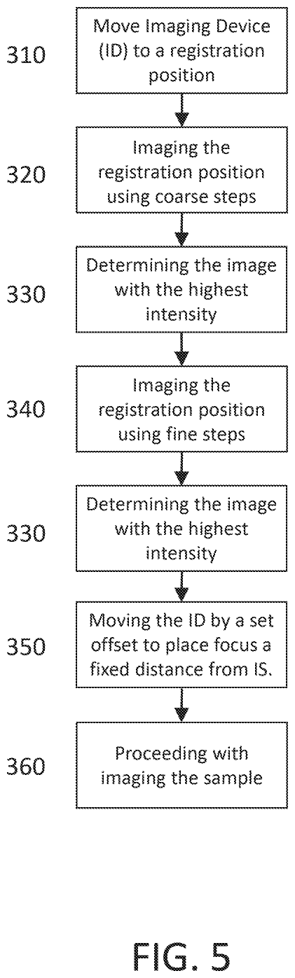

A method of registering an imaging system to an imaging window using an optical registration system will now be described. The optical registration system and the other components contained therein, including the imaging system and the imaging window, can be substantially similar in form and/or function to the optical registration system 100 and 200, sample containers 400 and 500, etc., described above with respect to FIGS. 1-4 and 6-8, respectively. Accordingly, such similar portions and/or aspects are not described in further detail herein. As shown in FIG. 5, a method of optically registering an imaging system to an imaging window can include the following steps: (1) moving the imaging device to a registration position 310, (2) imaging the registration position using coarse steps 320, (3) determining the image with the highest intensity, which indicates the location where the focus is at the imaging surface 330, (4) imaging the registration position using fine steps 340, (5) repeating step (3), (6) moving the imaging device by a set offset to place the focus a fixed distance from the imaging surface 350, and (7) proceeding with imaging of the sample 360.

In some embodiments, the target distance between the imaging device and top surface in process 330 can be determined by identifying locations along the scan where changes in the amplitude of the reflected sample light signal are large compared to the background noise. For example, a scan can be performed such that the focal point of the imaging device crosses both the top surface and the bottom surface of the imaging window. In embodiments where the imaging device is an OCT system, the top surface and the bottom surface can appear as peaks in the reflected sample light signal separated by a distance corresponding to the thickness of the imaging window. The top surface can be then identified from the two peaks based on the scan direction, e.g., towards the sample or away from the sample (e.g., a direction of the light being emitted relative to the bottom and top surfaces). The location of the top surface can be determined more precisely by using progressively finer steps when moving the focal point position in processes 320 and 340. In some embodiments, multiple scans of the focal point can be performed and averaged to reduce noise and other sources of random error, thus improving registration accuracy. The criteria to check whether the top surface has been located sufficiently in process 350 can be based on a user defined threshold, e.g., the location of the top surface is known to within 5 μm, compared to a parameter describing the uncertainty of the location, e.g., the standard deviation for multiple scans.

In some embodiments, methods of registering an imaging device, such as the example method depicted in FIG. 5, can be performed by a processor, e.g., a processor of an imaging system and/or a remote processor operatively coupled to the imaging system. The processor can control one or more components of the imaging system to register the imaging device, analyze data associated with light signals to identify a location of a sample imaging surface and/or a focal point of the imaging device, etc. In some embodiments, the processor can also be configured to perform imaging functions associated with the imaging system.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters and configurations described herein are meant to be exemplary inventive features and that other equivalents to the specific inventive implementations described herein may be realized. It is, therefore, to be understood that the foregoing implementations are presented by way of example and that, within the scope of the appended claims and equivalents thereto, inventive implementations may be practiced otherwise than as specifically described and claimed. Inventive implementations of the present disclosure are directed to each individual feature, system, article, and/or method described herein. In addition, any combination of two or more such features, systems, articles, and/or methods, if such features, systems, articles, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system, comprising:
a sample container configured to hold a biological tissue sample, the sample container including an imaging window having an imaging surface configured to contact the biological tissue sample;
an imaging device configured to emit light toward the imaging window and measure a portion of the light reflected by the imaging window;
a positioning element configured to move the imaging device relative to the imaging window;
a processor operatively coupled to the imaging device and the positioning element, the processor configured to:
receive data representative of the reflected portion of the light;
determine a location of the imaging surface relative to the imaging device based on the received data; and
move, via the positioning element, the imaging device to align a focal point associated with the imaging device relative to the imaging surface.

2. The system of claim 1, further comprising a frame configured to support the sample container, the frame including an aperture configured to align with an outer portion of the imaging window,
the imaging device configured to emit the light through the aperture and detect the portion of the light reflected through the aperture.

3. The system of claim 2, wherein the aperture is a first aperture and the frame further includes a second aperture configured to align with an inner portion of the imaging window,
the first and second apertures defining a scanning area of the imaging window.

4. The system of claim 1, further comprising a frame including a plurality of plates, the plurality of plates including:
a first plate configured to couple to a portion of the sample container; and
a second plate configured to couple to the imaging device such that the imaging device is disposed below the sample container within a cavity defined by the plurality of plates.

5. The system of claim 1, wherein the processor is configured to determine a location of the imaging surface relative to the imaging device by:
identifying a peak in the data representative of the reflected portion of the light, the peak representative of a portion of the reflected portion of the light reflected at the imaging surface; and
determining the location of the imaging surface relative to the imaging device based on a location of the peak in the data representative of the reflected portion of the light.

6. The system of claim 1, wherein:
the imaging window further includes a bottom surface configured to be orientated toward the imaging device, the bottom surface spaced from the imaging surface by a thickness of the imaging window;
the data representative of the reflected portion of the light includes a first peak representative of a portion of the light reflected by the bottom surface and a second peak representative of a portion of the light reflected by the imaging surface, the first and second peaks separated by a distance equal to the thickness of the imaging window; and
the processor is configured to determine the location of the imaging surface based on the first and second peaks and a direction of the light relative to the bottom surface and the imaging surface.

7. The system of claim 1, wherein the positioning element includes one or more motors configured to move the imaging device along a plurality of axes.

8. The system of claim 1, wherein the processor is further configured to:
image, via the imaging device, the biological tissue sample when the imaging device is at a plurality of locations relative to the imaging surface;
determine a location from the plurality of locations having an image with an intensity greater than that of the remaining locations from the plurality of locations; and
move, via the positioning element, the imaging device to the location.

9. The system of claim 1, wherein the imaging window includes one or more registration indicia each configured to mark a location on the imaging window at which to emit the light for aligning the focal point relative to the imaging surface.

10. The system of claim 1, wherein the imaging window includes an image contrast coating disposed along the imaging surface, the image contrast coating configured to increase a portion of the light being reflected at the imaging surface.

11. The system of claim 10, wherein the imaging window further includes:
a bottom surface configured to be orientated toward the imaging device; and
an anti-reflection coating disposed along the bottom surface and configured to reduce a portion of the light being reflected at the bottom surface.

12. An apparatus, comprising:
a frame including a plate configured to support a sample container that holds a biological tissue sample, the frame including one or more apertures aligned with a portion of an imaging window of the sample container;
an imaging device configured to emit light toward the imaging window through the one or more apertures and measure a portion of the light reflected by the imaging window;
a positioning element configured to move the imaging device relative to the one or more apertures;
a processor operatively coupled to the imaging device and the positioning element, the processor configured to:
receive data representative of the reflected portion of the light;
determine a location of an imaging surface of the imaging window relative to the imaging device based on the received data; and
move, via the positioning element, the imaging device to align a focal point associated with the imaging device relative to the imaging surface.

13. The apparatus of claim 12, wherein the one or more apertures includes:
a first aperture configured to align with an outer portion of the imaging window; and
a second aperture configured to align with an inner portion of the imaging window,
the first and second apertures defining a scanning area of the imaging window.

14. The apparatus of claim 12, wherein the frame is configured to support the imaging device and defines a cavity within which the imaging device is disposed.

15. The apparatus of claim 12, wherein the processor is configured to determine a location of the imaging surface relative to the imaging device by:
identifying a peak in the data representative of the reflected portion of the light, the peak representative of a portion of the reflected portion of the light reflected at the imaging surface; and
determining the location of the imaging surface relative to the imaging device based on a location of the peak in the data representative of the reflected portion of the light.

16. The apparatus of claim 12, wherein:
the data representative of the reflected portion of the light includes a first peak representative of a portion of the light reflected by a bottom surface of the imaging window and a second peak representative of a portion of the light reflected by the imaging surface, the first and second peaks separated by a distance equal to a thickness of the imaging window; and
the processor is configured to determine the location of the imaging surface based on the first and second peaks and a direction of the light relative to the bottom surface and the imaging surface.

17. The apparatus of claim 12, wherein the positioning element includes one or more motors configured to move the imaging device along a plurality of axes.

18. A method, comprising:
positioning, via a positioning element of an imaging system, an image device at a registration location;
determining a location of an imaging surface of a imaging window of a sample container relative to an imaging device of the imaging system, the sample container configured to hold a biological tissue sample;
moving, via the positioning element, the image device to a plurality of locations;
imaging, via the imaging device, the biological tissue sample at each location from the plurality of locations;
determining a location from the plurality of locations having an image with an intensity greater than that of the remaining locations from the plurality of locations; and
moving, via the positioning element, the imaging device to the location.

19. The method of claim 18, wherein the plurality of locations is a first plurality of locations, the location is a first location, and moving the image device to a plurality of locations includes moving the image device using coarse steps to the first plurality of locations, the method further comprising:
moving, via the positioning element, the imaging device using fine steps to a second plurality of locations near the first location;
imaging, via the imaging device, the biological tissue sample at each location from the second plurality of locations;
determining a second location from the second plurality of locations having an image with an intensity greater than that of the remaining locations from the second plurality of locations; and
moving, via the positioning element, the imaging device to the second location.

20. The method of claim 18, wherein determining the location of the imaging surface includes:
causing the imaging device to emit light at the imaging window;
receiving data representative of a portion of the light reflected by the imaging window;
identifying a peak in the received data, the peak representative of a portion of the reflected portion of the light reflected at the imaging surface; and
determining the location of the imaging surface based on a location of the peak in the received data.
